(19) United States
(12) Patent Application Publication
(10) Pub. No.: US 2016/0142950 A1
(43) Pub. Date: May 19, 2016

(54) HYBRID-ANTENNA MODE OF AN APPARATUS CONFIGURED FOR WIRELESS COMMUNICATION

(71) Applicant: QUALCOMM Incorporated, San Diego, CA (US)

(72) Inventors: Awnit Kumar, Reading (GB); Zhi-Zhong Yu, Reading (GB); Bahadir Canpolat, Fleet (GB); Manmohan Rawat, Farnborough (GB)

(21) Appl. No.: 14/540,500

(22) Filed: Nov. 13, 2014

(51) Int. Cl. H04W 36/00; H04B 7/04; H04W 24/10

(52) U.S. Cl. CPC H04W 36/0088; H04W 24/10; H04B 7/04

(57) ABSTRACT

Various aspects of the present disclosure provide for an apparatus configured to receive a transmission from a serving cell utilizing a single antenna while the apparatus is operating in a first mode. While the apparatus is operating in a second mode, the apparatus may be configured to measure a signal quality of a neighbor cell utilizing at least one of two or more antennas and use receive diversity (RxD) to receive the transmission from the serving cell utilizing the two or more antennas. While the apparatus is operating in a third mode, the apparatus may be further configured to use only RxD to receive the transmission from the serving cell utilizing the two or more antennas. The first mode may be a single-antenna mode. The second mode may be a hybrid-antenna mode. The third mode may be an RxD-only mode.

### TECHNICAL FIELD

Aspects of the present disclosure relate, generally, to wireless communication and, more particularly, to a hybrid-antenna mode of an apparatus configured for wireless communication.

### BACKGROUND

Existing devices may be configured for wireless communication in various communication systems. Examples of such communications systems include code-division multiple access (CDMA) systems, time-division multiple access (TDMA) systems, frequency-division multiple access (FDMA) systems, and orthogonal frequency-division multiple access (OFDMA) systems. Such devices may include two or more antennas. Utilizing two or more antennas instead of a single antenna may improve the performance of such devices. For example, such devices may experience less co-channel interference (CCI) and/or adjacent-channel interference (ACI) than single-antenna devices. However, utilizing two or more antennas may consume more power than utilizing a single antenna. Also, two or more antennas may sometimes detect a signal quality that is higher than the signal quality that would otherwise be detected by a single-antenna. As such, utilizing two or more antennas may cause such devices to report artificially high signal qualities to a serving cell, which, in turn, may refrain from sending an otherwise appropriate handover command to such devices. Consequently, utilizing two or more antennas may sometimes result in a disconnection in communication (e.g., a dropped call) and a poor user experience. Existing systems may benefit from enhancements that overcome such limitations and enhance the quality of the user experience.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure describe an apparatus configured to receive a transmission from a serving cell utilizing a single antenna while the apparatus is operating in a first mode. In some configurations, the apparatus may be further configured to measure a signal quality of the serving cell while the apparatus is operating in the first mode. In such configurations, the apparatus may be further configured to determine whether to change operation of the apparatus from the first mode to a second mode based on the measured signal quality of the serving cell while the apparatus is operating in the first mode.

While the apparatus is operating in the second mode, the apparatus may be configured to measure a signal quality of a neighbor cell utilizing at least one of two or more antennas and use receive diversity (RxD) to receive the transmission from the serving cell utilizing the two or more antennas. In some configurations, the apparatus may be further configured to report the measured signal quality of the neighbor cell to the serving cell for evaluation of a handover of the apparatus from the serving cell to the neighbor cell.

In some configurations, the apparatus may be configured to measure a signal quality of the serving cell while the apparatus is operating in the second mode. In such configurations, the apparatus may be further configured to determine whether to change operation of the apparatus from the second mode to a third mode based on the measured signal quality of the serving cell while the apparatus is operating in the second mode.

While the apparatus is operating in the third mode, the apparatus may be further configured to use only RxD to receive the transmission from the serving cell utilizing the two or more antennas. In various configurations, the first mode comprises a single-antenna mode, the second mode comprises a hybrid-antenna mode, and the third mode comprises an RxD-only mode. In various configurations, a strength of a signal received at the at least one of the two or more antennas is weaker than a strength of the signal received at another one or more of the two or more antennas. In various configurations, the transmission from the serving cell comprises bursts on a traffic channel (TCH) in a Global Systems for Mobile Communications (GSM) network.

In various aspects of the present disclosure, a method of wireless communication by an apparatus includes receiving a transmission from a serving cell utilizing a single antenna while the apparatus is operating in a first mode. While the apparatus is operating in a second mode, the method further includes measuring a signal quality of a neighbor cell utilizing at least one of two or more antennas and using RxD to receive the transmission from the serving cell utilizing the two or more antennas.

In various aspects of the present disclosure, an apparatus for wireless communication includes a transceiver, a memory, and at least one processor coupled to the memory. The transceiver may include two or more antennas. The at least one processor may be configured to receive a transmission from a serving cell utilizing a single antenna while the apparatus is operating in a first mode. While the apparatus is operating in a second mode, the at least one processor may be further configured to measure a signal quality of a neighbor cell utilizing at least one of two or more antennas and use RxD to receive the transmission from the serving cell utilizing the two or more antennas.

In various aspects of the present disclosure, a computer-readable medium may include computer-executable code configured to receive a transmission from a serving cell utilizing a single antenna while operating in a first mode. While operating in a second mode, the computer-executable code may be further configured to measure a signal quality of a neighbor cell utilizing at least one of two or more antennas and use RxD to receive the transmission from the serving cell utilizing the two or more antennas.

In various aspects of the present disclosure, an apparatus for wireless communication may include means for receiving a transmission from a serving cell utilizing a single antenna while the apparatus is operating in a first mode. While operating in a second mode, the apparatus may further include means for measuring a signal quality of a neighbor cell utilizing at least one of two or more antennas and using RxD to receive the transmission from the serving cell utilizing the two or more antennas.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example hardware implementation of an apparatus in accordance with various aspects of the present disclosure.

FIG. 2 is a diagram illustrating another example hardware implementation of an apparatus in accordance with various aspects of the present disclosure.

FIG. 3 is a diagram illustrating an example of an access network in a wireless communication system in accordance with various aspects of the present disclosure.

FIG. 4 is a timing diagram illustrating various features of a hybrid-antenna mode in accordance with various aspects of the present disclosure.

FIG. 5 is a state diagram illustrating an example of various modes and operations of an apparatus in accordance with various aspects of the present disclosure.

FIGS. 6-7 are diagrams illustrating various examples of methods and/or processes performed by an apparatus in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

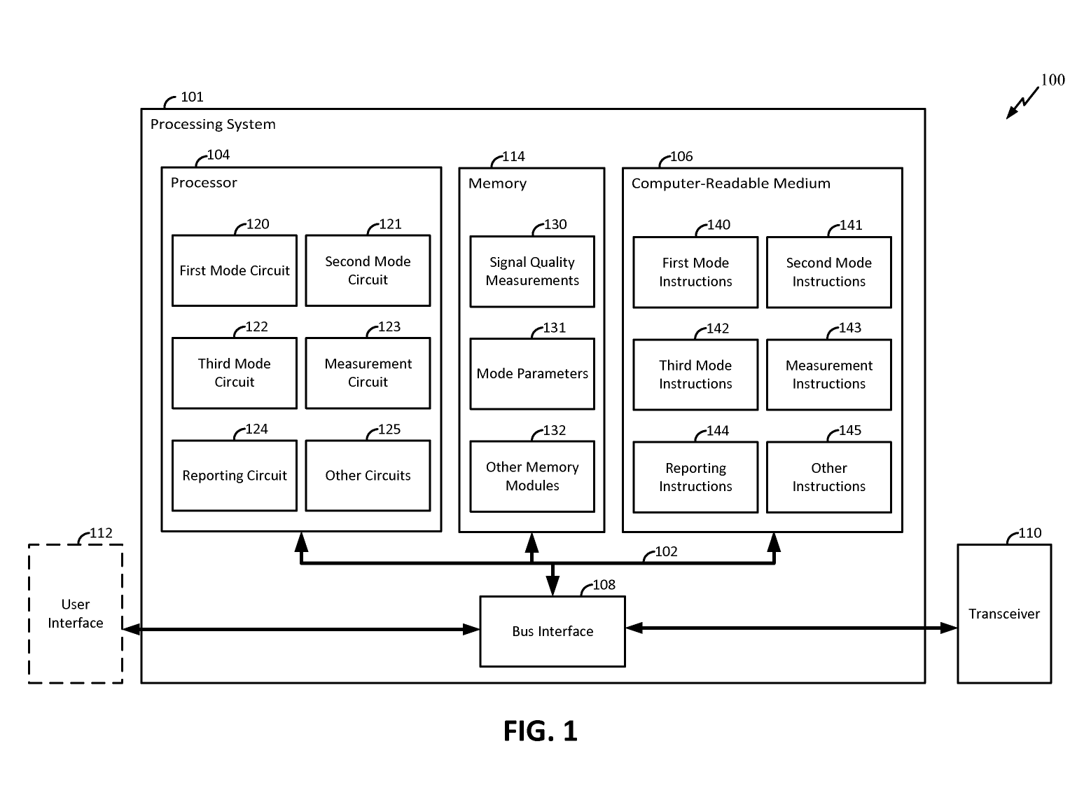

FIG. 1 is a diagram illustrating an example hardware implementation of an apparatus in accordance with various aspects of the present disclosure. Although various portions of the description provided herein may refer to such an apparatus as “apparatus 100” or “apparatus 100-a2,” one of ordinary skill in the art will understand that the corresponding reference characters (e.g., 100, 100-a2) utilized herein are provided for illustrative purposes and that such reference characters may refer to the same apparatus without deviating from the scope of the present disclosure. Generally, the apparatus 100 may be any apparatus configured to communicate with another apparatus. By way of example and not limitation, the apparatus 100 may be a cellular telephone, a user equipment, an access terminal, a smartphone, a tablet computer, a laptop computer, a desktop computer, personal digital assistant (PDA), a digital video recorder (DVR), an internet appliance, a gaming console, an e-reader, and/or any other apparatus configured to communicate with another apparatus.

The apparatus 100 may include a user interface 112. The user interface 112 may be configured to receive one or more inputs from a user of the apparatus 100. The user interface 112 may also be configured to display information (e.g., text and/or images) to the user of the apparatus 100. The user interface 112 may exchange data to and/or from the processing system 101 via the bus interface 108.

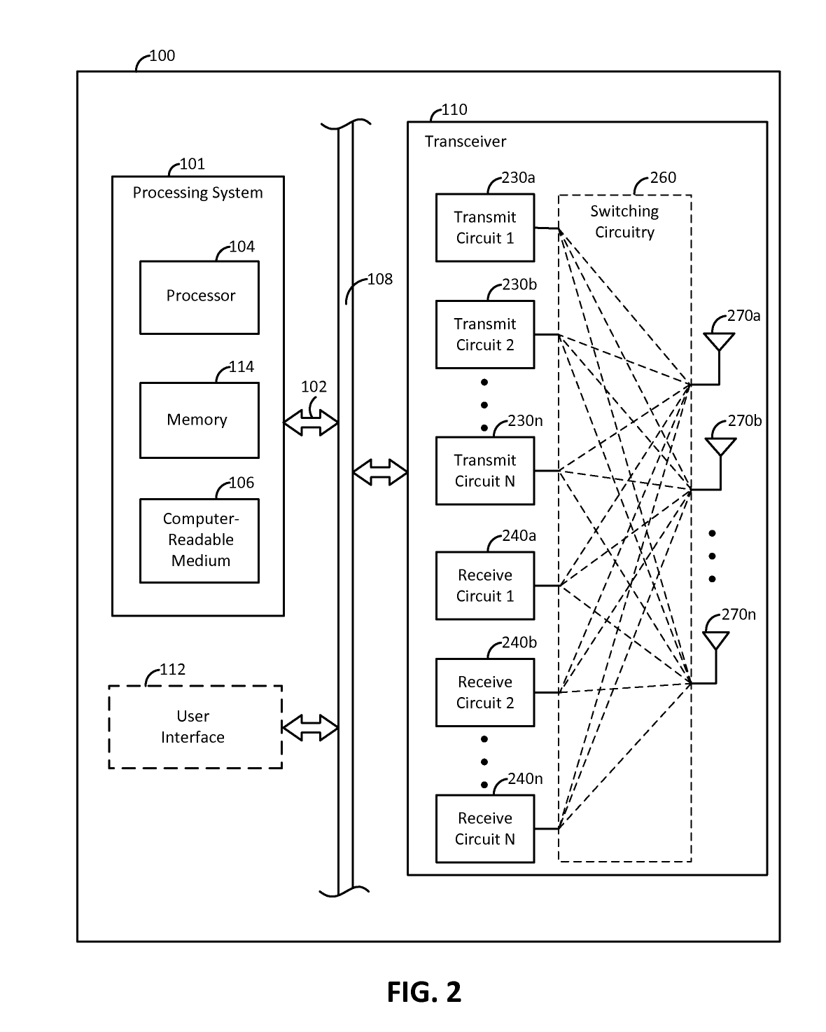

The apparatus 100 may also include a transceiver 110. The transceiver 110 may be configured to receive data and/or transmit data during communication with another apparatus. The transceiver 110 provides a means for communicating with another apparatus via a transmission medium. The transceiver 110 may be configured to perform such communication using various types of technologies. One of ordinary skill in the art will understand that many types of communication technologies may be used without deviating from the scope of the present disclosure. Additional description regarding the transceiver 110 is provided herein with reference to FIG. 2.

The apparatus 100 may also include a processing system 101. The processing system 101 may include a memory 114, one or more processors 104, a computer-readable medium 106, and a bus interface 108. The bus interface 108 may provide an interface between a bus 102 and the transceiver 110. The memory 114, the one or more processors 104, the computer-readable medium 106, and the bus interface 108 may be connected together via the bus 102.

The processor 104 may include a first mode circuit 120. The first mode circuit 120 may include various hardware components and/or software modules that can perform various functions and/or enable various aspects associated with a first mode of the apparatus 100. In some configurations, the first mode is a single-antenna mode, which is described in greater detail below. The first mode circuit 120 may provide the means for receiving a transmission from a serving cell utilizing a single antenna while the apparatus 100 is operating in a first mode.

In some configurations, the processor 104 may also include a measurement circuit 123. The measurement circuit 123 may include various hardware components and/or software modules that can measure signal quality, such as the signal quality received at any of the antennas of the apparatus 100. The signal may be received from a serving cell and/or a neighbor cell. The measurement circuit 123 may provide the means for measuring a signal quality of the serving cell while the apparatus 100 is operating in the first mode. The first mode circuit 120 may provide the means for determining whether to change operation of the apparatus 100 from the first mode to a second mode based on the measured signal quality of the serving cell while the apparatus 100 is operating in the first mode.

The processor 104 may also include a second mode circuit 121. The second mode circuit 121 may include various hardware components and/or software modules that can perform various functions and/or enable various aspects associated with a second mode of the apparatus 100. In some configurations, the second mode is a hybrid-antenna mode, which is described in greater detail below. The second mode circuit 121 may provide the means for measuring a signal quality of a neighbor cell utilizing at least one of two or more antennas and using receive diversity (RxD) to receive the transmission from the serving cell utilizing the two or more antennas while the apparatus 100 is operating in the second mode.

In some configurations, the processor 104 may also include a reporting circuit 124. The reporting circuit 124 may include various hardware components and/or software modules that can report information (e.g., signal quality) to a cell (e.g., a serving cell of the apparatus 100). The reporting circuit 124 may provide the means for reporting the measured signal quality of the neighbor cell to the serving cell for evaluation of a handover of the apparatus 100 from the serving cell to the neighbor cell.

In some configurations, the measurement circuit 123 may provide the means for measuring a signal quality of the serving cell while the apparatus 100 is operating in the second mode. In such configurations, the second mode circuit 121 may provide the means for determining whether to change operation of the apparatus 100 from the second mode to a third mode based on the measured signal quality of the serving cell while the apparatus 100 is operating in the second mode.

The processor 104 may also include a third mode circuit 122. The third mode circuit 122 may include various hardware components and/or software modules of the processor 104 that can perform various functions and/or enable various aspects associated with a third mode of operation of the apparatus 100. In some configurations, the third mode is an RxD-only mode, which is described in greater detail below. The third mode circuit 122 may provide the means for using only RxD to receive the transmission from the serving cell utilizing the two or more antennas while the apparatus 100 is operating in the third mode. One of ordinary skill in the art will understand that the processor 104 may also include various other circuits 125. The other circuits 125 may be configured to perform any one or more of the features, functions, methods, processes, and/or aspects described herein.

The computer-readable medium 106 may include various instructions. The instructions may include computer-executable code configured to perform various functions and/or enable various aspects described herein. The computer-executable code may be executed by various hardware components of the processing system 101 (e.g., specifically, the processor 104). The instructions may be a part of various software programs and/or software modules.

The computer-readable medium 106 may include first mode instructions 140. The first mode instructions 140 may include computer-executable code configured to perform various functions and/or enable various aspects associated with a first mode of the apparatus 100. In some configurations, the first mode is a single-antenna mode, which is described in greater detail below. The first mode instructions 140 may be configured to receive a transmission from a serving cell utilizing a single antenna while the apparatus 100 is operating in a first mode.

In some configurations, the computer-readable medium 106 may also include measurement instructions 143. The measurement instructions 143 may include computer-executable code configured to measure signal quality, such as the signal quality received at any of the antennas of the apparatus 100. The signal may be received from a serving cell and/or a neighbor cell. Specifically, the measurement instructions 143 may include computer-executable code configured to measure a signal quality of the serving cell while the apparatus 100 is operating in the first mode. The first mode instructions 140 may include computer-executable code configured to determine whether to change operation of the apparatus 100 from the first mode to a second mode based on the measured signal quality of the serving cell while the apparatus 100 is operating in the first mode.

The computer-readable medium 106 may also include second mode instructions 141. The second mode instructions 141 may include computer-executable code configured to perform various functions and/or enable various aspects associated with a second mode of the apparatus 100. In some configurations, the second mode is a hybrid-antenna mode, which is described in greater detail below. The second mode instructions 141 may include computer-executable code configured to measure a signal quality of a neighbor cell utilizing at least one of two or more antennas and using receive diversity (RxD) to receive the transmission from the serving cell utilizing the two or more antennas while the apparatus 100 is operating in the second mode.

In some configurations, the computer-readable medium 106 may also include reporting instructions 144. The reporting instructions 144 may include computer-executable code configured to report information (e.g., signal quality) to a cell (e.g., a serving cell of the apparatus 100). Specifically, the reporting instructions 144 may include computer-executable code configured to report the measured signal quality of the neighbor cell to the serving cell for evaluation of a handover of the apparatus 100 from the serving cell to the neighbor cell.

In some configurations, the measurement instructions 143 may include computer-executable code configured to measure a signal quality of the serving cell while the apparatus 100 is operating in the second mode. In such configurations, the second mode instructions 141 may include computer-executable code configured to determine whether to change operation of the apparatus 100 from the second mode to a third mode based on the measured signal quality of the serving cell while the apparatus 100 is operating in the second mode.

The computer-readable medium 106 may also include third mode instructions 142. The third mode instructions 142 may include computer-executable code configured to perform various functions and/or enable various aspects associated with a third mode of the apparatus 100. In some configurations, the third mode is an RxD-only mode, which is described in greater detail below. The third mode instructions 142 may include computer-executable code configured to use only RxD to receive the transmission from the serving cell utilizing the two or more antennas while the apparatus 100 is operating in the third mode. One of ordinary skill in the art will understand that the computer-readable medium 106 may also include various other instructions 145. The other instructions 145 may include computer-executable code configured to perform any one or more of the features, functions, methods, processes, and/or aspects described herein.

The memory 114 may include various memory modules. The memory modules may be configured to store, and have read therefrom, various values and/or information by the processor 104, or any of its circuits 120, 121, 122, 123, 124, 125. The memory modules may also be configured to store, and have read therefrom, various values and/or information upon execution of the computer-executable code included in the computer-readable medium 106, or any of its instructions 140, 141, 142, 143, 144, 145.

In some configurations, the memory 114 may include signal quality measurements 130. As described above with reference to the measurement circuit 123 and the measurement instructions 143, the apparatus 100 may measure various signal qualities. The values of the measured signal qualities may be stored in, and read from, the signal quality measurements 130. In some configurations, the memory 114 may also include mode parameters 131. As described above with reference to first mode circuit 120 and second mode circuit 121 as well as the first mode instructions 140 and the second mode instructions 141, the apparatus 100 may determine whether to change operation from one mode to another mode. As also described above, such determinations may be based on the measured signal quality. The parameters (e.g., specific thresholds, signal quality metrics, etc.) that affect the aforementioned determination may be stored, and read from, the mode parameters 131. One of ordinary skill in the art will understand that the memory 114 may also include various other memory modules 132. The other memory modules 132 may be configured for storing information therein, and reading information therefrom, with respect to any of the features, functions, methods, processes, and/or aspects described herein.

One of ordinary skill in the art will further understand that the apparatus 100 may include alternative and/or additional elements without deviating from the scope of the present disclosure. In accordance with various aspects of the present disclosure, an element, or any portion of an element, or any combination of elements may be implemented with a processing system 101 that includes one or more processors 104. Examples of the one or more processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system 101 may be implemented with a bus architecture, represented generally by the bus 102 and bus interface 108. The bus 102 may include any number of interconnecting buses and bridges depending on the specific application of the processing system 101 and the overall design constraints. The bus 102 may link together various circuits including the one or more processors 104, the memory 114, and the computer-readable media 106. The bus 102 may also link various other circuits such as timing sources, peripherals, voltage regulators, and power management circuits, which are well known in the art.

The one or more processors 104 may be responsible for managing the bus 102 and general processing, including the execution of software stored on the computer-readable medium 106. The software, when executed by the one or more processors 104, causes the processing system 101 to perform the various functions described below for any one or more apparatuses. The computer-readable medium 106 may also be used for storing data that is manipulated by the one or more processors 104 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 106 may also include, by way of example, a carrier wave, a transmission line, and any other suitable medium for transmitting software and/or instructions that may be accessed and read by a computer. The computer-readable medium 106 may reside in the processing system 101, external to the processing system 101, or distributed across multiple entities including the processing system 101. The computer-readable medium 106 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

FIG. 2 is a diagram illustrating another example hardware implementation of an apparatus in accordance with various aspects of the present disclosure. The apparatus 100 may include two or more antennas (e.g., antennas 270a, 270b, . . . , 270n), which may be used in the transmission and/or reception of wireless communications to and/or from the apparatus 100. The apparatus 100 may include one or more transmit circuits (e.g., transmit circuits 230a, 230b, . . . , 230n) and one or more receive circuits (e.g., receive circuits 240a, 240b, . . . , 240n). In some configurations, the one or more transmit circuits (e.g., transmit circuits 230a, . . . , 230n) and the one or more receive circuits (e.g., receive circuits 240a, 240b, . . . , 240n) may be coupled to the plurality of antennas (e.g., antennas 270a, 270b, . . . , 270n) by way of a switching circuitry 260. However, the switching circuitry 260 is optional. One of ordinary skill in the art will understand that the switching circuitry 260 may be omitted without deviating from the scope of the present disclosure. For example, a direct connection may exist between each of the antennas (e.g., antennas 270a, 270b, . . . , 270n) and each of the transmit circuits (e.g., transmit circuits 230a, 230b, . . . , 230n) and/or receive circuits (e.g., receive circuits 240a, 240b, . . . , 240n) without deviating from the scope of the present disclosure.

A receiver circuit (e.g., receive circuit 240a, 240b, . . . , 240n) may receive a signal from one or more of the antennas (e.g., antennas 270a, 270b, . . . , 270n), demodulate and process the received signal, and provide the demodulated and processed signals to the processor 104. The receiver circuit (e.g., receive circuit 240a, 240b, . . . , 240n) may be a receiver, a receive chain, or any other suitable means for receiving a signal. Each receive circuit (e.g., receive circuit 240a, 240b, . . . , 240n) may include components that are used to perform tasks related to reception and filtration of incoming signals, frequency conversion, gain control, and baseband processing to provide a digital output to the processor 104.

A transmit circuit (e.g., transmit circuit 230a, 230b, . . . , 230n) may be configured to receive signals from the processor 104, process and modulate the signals, and transmit the processed and modulated signals using one or more of the antennas (e.g., antennas 270a, 270b, . . . , 270n). The transmit circuit (e.g., transmit circuit 230a, 230b, . . . , 230n) may be a transmitter, a transmitter chain, or any other suitable means for transmitting a signal. In some configurations, the transmit circuit(s) (e.g., transmit circuit(s) 230a, 230b, . . . , 230n) and the receiver circuit(s) (e.g., receiver circuit(s) 240a, 240b, . . . , 240n) may be included in a single transceiver circuit (e.g., transceiver 110).

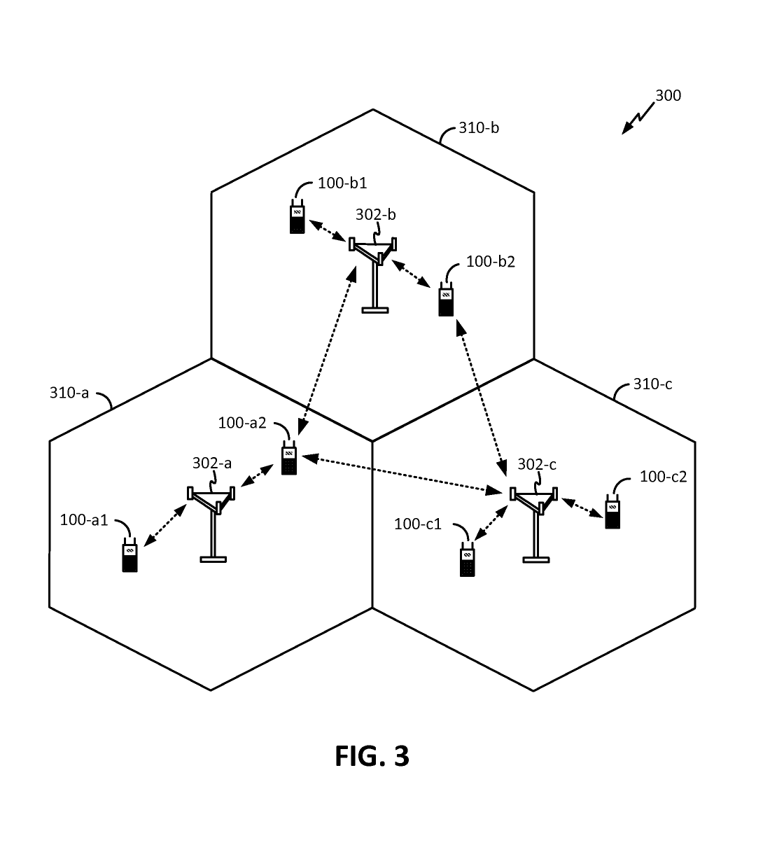

FIG. 3 is a diagram illustrating an example of a wireless communication system 300. By way of example and not limitation, the wireless communication system 300 may be a Global System for Mobile Communication (GSM) system. Although various features and/or functions described herein may refer to a GSM system, one of ordinary skill in the art will understand that one or more aspects of the present disclosure may be implemented in various other wireless communication systems, network architectures, and/or communication standards without deviating from the scope of the present disclosure.

The wireless communication system 300 may include one or more cells 302-a, 302-b, 302-c, one or more apparatuses 100-a1, 100-a2, 100-b1, 100-b2, 100-c1, 100-c2, one or more base station controllers (BSC), and a core network providing access to a public switched telephone network (PSTN) (e.g., via a mobile switching center/visitor location register (MSC/VLR)) and/or to an IP network (e.g., via a packet data switching node (PDSN)). The wireless communication system 300 may support operation on multiple carriers (waveform signals of different frequencies). Multi-carrier transmitters may transmit modulated signals simultaneously on the multiple carriers. Each modulated signal may utilize any suitable multiplexing or multiple access scheme, including, but not limited to, code division multiple access (CDMA), time division multiple access (TDMA), orthogonal frequency division multiple access (OFDMA), and Single Carrier Frequency Division Multiple Access (SC-FDMA).

The cells 302-a, 302-b, 302-c may wirelessly communicate with the apparatuses 100-a1, 100-a2, 100-b1, 100-b2, 100-c1, 100-c2 via one or more cell antennas. The cells 302-a, 302-b, 302-c may each include a device that facilitates wireless connectivity. For example, the cells 302-a, 302-b, 302-c may include access points, base transceiver stations (BTS), radio base stations, radio transceivers, transceiver functions, basic service sets (BSS), extended service sets (ESS), Node Bs, femto cells, pico cells, and/or another suitable device. The cells 302-a, 302-b, 302-c may be configured to communicate with the apparatuses 100-a1, 100-a2, 100-b1, 100-b2, 100-c1, 100-c2. Each of the cells 302-a, 302-b, 302-c may provide communication coverage for a respective coverage area. The coverage area for cells 302-a, 302-b, 302-c is coverage area 310-a, 310-b, 310-c, respectively.

As described above, the apparatus 100-a2 may include two or more antennas. For example, the apparatus 100-a2 may include antenna 270a and antenna 270b. However, one of ordinary skill in the art will understand that the apparatus 100-a2 may include more than two antennas without deviating from the scope of the present disclosure. For example, the apparatus 100-a2 may have up to n-number of antennas (e.g., antenna 270n) without deviating from the scope of the present disclosure. The apparatus 100-a2 may perform various functions and/or include various features based on the ‘mode’ of the apparatus 100-a2. Generally, the term ‘mode’ may refer to the instructions stored in the computer-readable medium 106, the parameter(s) stored in the memory 114, and/or circuit(s) included in the processor 104 that enable the apparatus 100-a2 to operate in a particular manner. Descriptions of non-limiting examples of various modes of operation are provided herein.

In some configurations, the apparatus 100-a2 may operate in a mode referred to herein as a ‘single-antenna mode.’ While operating in the single-antenna mode, the apparatus 100-a2 may utilize a single antenna for receiving transmissions. For example, while operating in the single-antenna mode, the apparatus 100-a2 may utilize only antenna 270a for receiving transmissions from a transmitter. The transmitter may be a serving cell 302-a. The term ‘serving cell’ may refer to a cell (e.g., a base station) with which the apparatus is currently communicating. The transmitter may also be a neighbor cell 302-b, 302-c. The term ‘neighbor cell’ may refer to a cell (e.g., a base station) with which the apparatus 100-a2 is not currently communicating but with which the apparatus 100-a2 could communicate upon receiving a corresponding handover command from the serving cell 302-a.

In some configurations, the apparatus 100-a2 may operate in a mode referred to herein as an ‘RxD-only mode.’ While operating in the RxD-only mode, the apparatus 100 may utilize two (or more) spatially-separated antennas for receiving transmissions. For example, while operating in the RxD-only mode, the apparatus 100 may utilize antenna 270a and antenna 270b for receiving transmissions from a transmitter, such as serving cell 302-a or a neighbor cell 302-b, 302-c. Generally, RxD may include combination diversity as well as switched diversity. Combination diversity may involve two (or more) spatially-separated antennas, wherein each antenna may be connected to its own independent receive circuit, and wherein those antennas operate at the same time to receive a transmission. The signals received by the antennas may be processed and eventually combined in a way that enhances the received signal quality. In contrast to combination diversity, switched diversity may involve the two (or more) spatially-separated antennas operating at different times (e.g., only one antenna operating at any time).

In existing systems, an apparatus may alternate between the single-antenna mode and the RxD-only mode. In some circumstances, the signal quality may be good (e.g., above a predetermined threshold). When the signal quality is good, an apparatus of existing systems may operate in the single-antenna mode. Over time, as the apparatus moves from one location to another location, the signal quality may deteriorate. When the signal quality is no longer good, the apparatus may change operation from the single-antenna mode to the RxD-only mode. Operating in the RxD-only mode may improve the capabilities of the apparatus to receive signals from the serving cell. However, due to such improved capabilities, the signal quality detected by an apparatus operating in the RxD-only mode may be higher than the signal quality that would have been reported if the apparatus was instead operating in the single-antenna mode. Accordingly, the signal quality reported to the serving cell may be artificially higher when the apparatus is operating in the RxD-only mode relative to the signal quality that would otherwise have been reported to the serving cell if the apparatus was instead operating in the single-antenna mode. As such, the serving cell may receive at least partially inaccurate information about the signal quality. Because the serving cell may not have entirely accurate information about the signal quality, the serving cell may not transmit a handover command to the apparatus in every circumstance where it is needed to prevent a disruption in communication (e.g., a dropped call). Furthermore, using RxD at all times (e.g., during the RxD-only mode) may consume more power than would be consumed if RxD is not used at all times.

The apparatus 100-a2 according to various aspect of the present disclosure provides for a mode referred to herein as a ‘hybrid-antenna mode.’ While operating in the hybrid-antenna mode, the apparatus 100-a2 may use RxD during a duration of time and not use RxD during another duration of time. Various types of scheduling may be implemented to control the duration of time for using RxD and the duration of time for not using RxD. When the apparatus is not using RxD, the apparatus 100-a2 may use at least one (or more) of its antennas to measure a signal quality of a neighbor cell. For example, referring to FIGS. 2 and 3, while operating in the hybrid-antenna mode, the apparatus 100-a2 may (i) measure a signal quality of a neighbor cell 302-b, 302-c utilizing antenna 270a and (ii) use RxD to receive transmissions from the serving cell 302-a utilizing antennas 270a, 270b. By operating in the hybrid-antenna mode, the apparatus 100-a2 benefits from the improved reception capabilities associated with using two (or more) antennas while also benefiting from the capability of measuring signal qualities of neighbor cells. Measurements of signal qualities of neighbor cells 302-b, 302-c may be reported to the serving cell 302-a. Based on such measurements, the serving cell 302-a may evaluate whether to transmit a handover command to the apparatus 100-a2 to handover the apparatus 100-a2 from the serving cell 302-a to neighbor cell 302-b or neighbor cell 302-c.

Various signal quality metrics may be implemented without deviating from the scope of the present disclosure. By way of example and not limitation, such signal quality metrics may include a receiver quality (RxQual) and/or a bit error probability (BEP). RxQual may be a metric used in GSM as part of a network measurement report. The value of the RxQual may be an integer value ranging from zero (0) up to seven (7), wherein a lower value (e.g., 0) indicates the highest signal quality and a higher value (e.g., 7) indicates the lowest signal quality. In some configurations, the value of the RxQual may correspond to an estimated number of bit errors in a number of bursts (e.g., bursts on the TCH). BEP may refer to an expected or estimated value for the bit error rate (BER). The BER may refer to the number of bit errors divided by the total number of transferred bits during a particular time interval. Various other metrics for measuring signal quality are known to one of ordinary skill in the art and may be implemented without deviating from the scope of the present disclosure.

As discussed in greater detail above, the apparatus 100-a2 utilizes (at least) one antenna 270a to measure the signal quality of a neighbor cell 302-b, 302-c. Because the apparatus 100-a2 reports the signal quality of the neighbor cell(s) 302-b, 302-c to the serving cell 302-a, the serving cell 302-a can evaluate whether the apparatus 100-a2 should be handed over from the serving cell 302-a to one of the neighbor cells 302-b, 302-c. The reporting of the signal quality of neighbor cells 302-b, 302-c and the evaluation of whether to handover the apparatus 100-a2 from the serving cell 302-a to one of the neighbor cells 302-b, 302-c may be ongoing as the apparatus 100-a2 moves throughout the coverage areas 310-a, 310-b, 310-c of various cells 302-a, 302-b,302-c. Ongoing measurements and evaluations, as described herein, increase the likelihood that the communication of the apparatus 100-a2 will not be disrupted (e.g., a call dropped) as the apparatus 100-a2 moves from one coverage area (e.g., coverage area 310-a) to another coverage area (e.g., coverage area 310-b and/or coverage area 310-c).

The apparatus 100-a2 may select which one (or more) of the two (or more) antennas to utilize for measurements of signal qualities of neighbor cells. In some configurations, the apparatus 100-a2 select the one (or more) antennas to utilize for measurements of signal qualities of neighbor cells based on the relative strength of signals received at the antennas. For example, referring to FIG. 2, the strength of signals received at antenna 270a may be weaker than the strength of signals received at antenna 270b. Accordingly, the apparatus 100-a2 may utilize antenna 270a for measurements of signal qualities of neighbor cells.

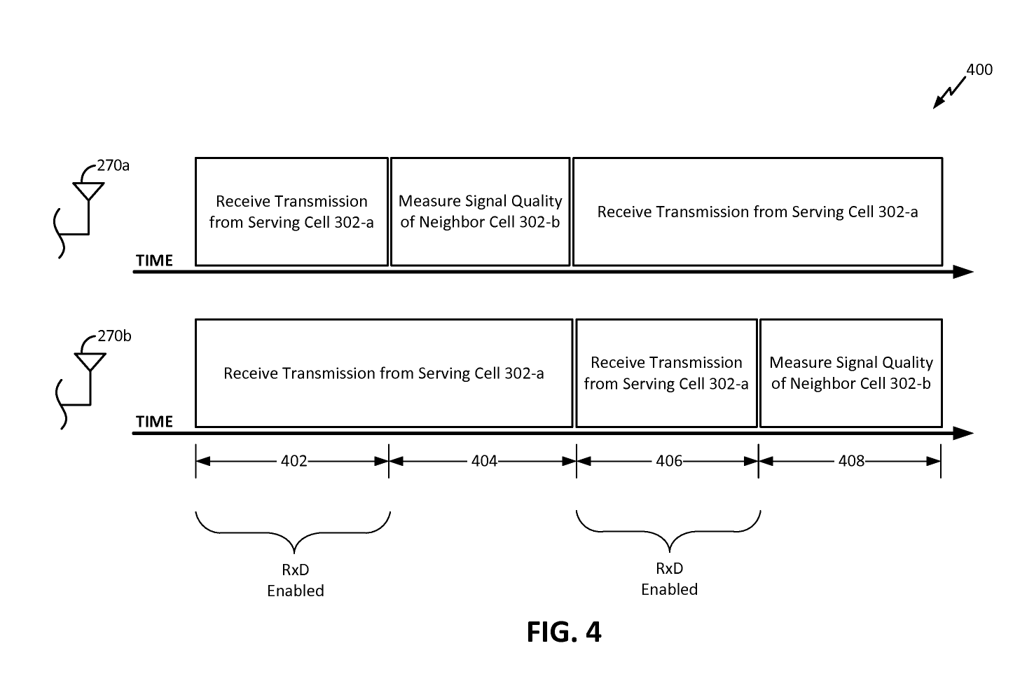

FIG. 4 is a timing diagram 400 illustrating example operations during the hybrid-antenna mode in accordance with various aspects of the present disclosure. The timing diagram 400 illustrates the reception of various signals at antennas 270a, 270b with respect to time. Although two antennas 270a, 270b are illustrated in FIG. 4, one of ordinary skill in the art will understand that additional antennas may be used without deviating from the scope of the present disclosure. In FIG. 4, time has been partitioned into time periods 402, 404, 406, 408. Although the time periods illustrated in FIG. 4 may appear similar in duration, one of ordinary skill in the art will understand that the time periods 402, 404, 406, 408 may each have various durations without deviating from the scope of the present disclosure.

In some configurations, at least one of two or more antennas may continuously receive transmissions from a serving cell. For example, antenna 270b may continuously receive transmissions from serving cell 302-a during time periods 402, 404. During a portion of this time period (402, 404), at least one other antenna of the two or more antennas may measure the signal quality of a neighbor cell. For example, antenna 270a may measure the signal quality of neighbor cell 302-b during time period 404. During time period 402, antenna 270a may receive transmissions from the serving cell 302-a. During time periods where antennas 270a, 270b are both receiving transmissions from the serving cell 302-a, the apparatus may be using RxD to receive transmissions from the serving cell 302-a. Accordingly, RxD is enabled during time period 402.

For the time period 402, 404, antenna 270-a may have been selected to measure the signal quality of the neighbor cell 302-b because the signal strength received at antenna 270-a may have been weaker than the signal strength received at antenna 270-b. However, over time, the signal strength received at antenna 270b may become weaker than the signal strength received at antenna 270a. For example, for the time period 406, 408, the signal strength received at antenna 270b may be weaker than the signal strength received at antenna 270a. Accordingly, antenna 270b may be selected to measure the signal quality of the neighbor cell 302-b. As such, during time period 408, antenna 270b may measure the signal quality of neighbor cell 302-b. Meanwhile, antenna 270a may continuously receive transmissions from serving cell 302-a during time periods 406, 408. Accordingly, RxD is enabled during time period 406 and the apparatus may use RxD during time period 406 to receive transmissions from the serving cell 302-a.

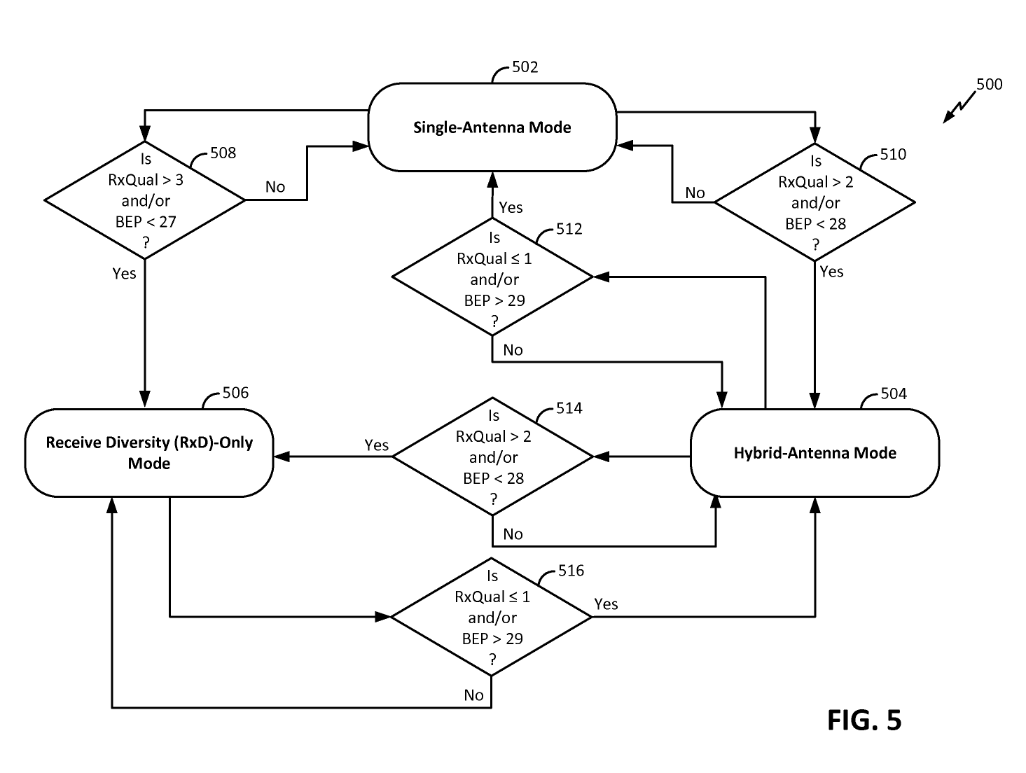

FIG. 5 is a state diagram 500 illustrating an example of various modes and operations of an apparatus (e.g., apparatus 100, 100-a2) in accordance with various aspects of the present disclosure. The state diagram 500 illustrates at least three states. One of ordinary skill in the art will understand that a fewer or greater number of states may be included without deviating from the scope of the present disclosure. Each state may include a characteristic set of behaviors, operations, functions, aspects, and/or features of the apparatus. The state of the apparatus may also be referred to as the mode of operation of the apparatus, which is described in greater detail above. The state, or mode, of the apparatus may change based on various parameters and/or conditions. Such parameters and/or conditions may be stored in, and read from, the mode parameters 131 of the memory 114, as described above with reference to FIG. 1. Such parameters and/or conditions may be used to transition the apparatus between various states, or modes. In some configurations, such parameters and/or conditions may be received channel metrics and/or signal quality metrics. Various types of such metrics exist and may be used without deviating from the scope of the present disclosure. By way of example and not limitations, such metrics may include RxQual and BEP, as described in greater detail above.

In some circumstances, the received signal quality may be good. For example, the signal quality may be good when the signal-to-noise (SNR) ratio is greater than 8 decibels (dB) for Gaussian Minimum Shift Keying (GMSK) and/or the SNR is greater than 10 dB for Eight Phase Shift Keying (8PSK). When the signal quality is good, the apparatus may operate in the single-antenna mode 502. As described in greater detail above, while operating in the single-antenna mode, the apparatus may utilize a single antenna (e.g., only antenna 270a) for receiving transmissions from a transmitter. The apparatus may prefer to operate in the single-antenna mode 502 because the use of a single antenna can assist the apparatus minimize power consumption. However, as the apparatus moves from one location to another location, the signal quality may deteriorate. The apparatus may determine whether to change operation from the single-antenna mode 502 to the RxD-only mode 506 based on the signal quality of the serving cell. For example, while the apparatus is operating in the single-antenna mode 502, at block 508, the apparatus may determine whether the RxQual has a value above three (3) and/or whether the BEP has a value below 27. If neither the RxQual has a value above three (3) nor the BEP has a value below 27, the apparatus may remain operating in the single-antenna mode 502. However, if the RxQual has a value above three (3) and/or the BEP has a value below 27, the apparatus may change operation from the single-antenna mode 502 to the RxD-only mode 506.

As described in greater detail above, while operating in the RxD-only mode 506, the apparatus may utilize two (or more) spatially-separated antennas (e.g., antennas 270a, 270b) for receiving transmissions from a transmitter (e.g., serving cell 302-a and/or neighbor cell(s) 302-b, 302-c). RxD may include combination diversity as well as switched diversity. Operating in the RxD-only mode 506 may improve the capabilities of the apparatus to receive signals from the serving cell. However, due to such improved capabilities, the signal quality detected at the apparatus operating in the RxD-only mode 506 may be artificially higher than the signal quality that would have been detected if the apparatus was instead operating in the single-antenna mode 502. Accordingly, the signal qualities reported to the serving cell may be higher when the apparatus is operating in the RxD-only mode 506 relative to the signal qualities that would otherwise have been reported to the serving cell if the apparatus was instead operating in the single-antenna mode 502. As such, the serving cell may receive at least partially inaccurate information about the signal qualities at the apparatus 100. Because the serving cell may not have entirely accurate information about the signal qualities of the serving cell, the serving cell may not transmit a handover command to the apparatus in every circumstance where it is needed to prevent a disruption in communication (e.g., a dropped call).

To reduce the likelihood of such undesirable outcomes (e.g., dropped calls), the apparatus may sometimes operate in the hybrid-antenna mode 504. As described in greater detail above, while operating in the hybrid-antenna mode 504, the apparatus may use RxD during a duration of time and not use RxD during another duration of time. When the apparatus is not using RxD, the apparatus may use at least one (or more) of its antennas to measure a signal quality of a neighbor cell. For example, referring to FIGS. 2 and 3, the apparatus 100-a2 may (i) measure a signal quality of a neighbor cell 302-b, 302-c utilizing only antenna 270a and (ii) use RxD to receive transmissions from the serving cell 302-a utilizing antennas 270a, 270b.

In some configurations, the apparatus may determine whether to change operation from the single-antenna mode 502 to the hybrid-antenna mode 504 based on signal qualities of the serving cell. For example, while operating in the single-antenna mode 502, at block 510, the apparatus may determine whether the RxQual has a value that exceeds two (2) and/or whether the BEP has a value below 28. (In some configurations, the apparatus may determine whether the SNR is below 6 dB for GMSK and/or the SNR is below 10 dB for 8PSK.) If neither the RxQual has a value that exceeds two (2) nor the BEP has a value below 28, the apparatus may remain operating in the single-antenna mode 502. However, if the RxQual has a value that exceeds two (2) and/or the BEP has a value below 28, the apparatus may change operation from the single-antenna mode 502 to the hybrid-antenna mode 504.

As described in greater detail above, while operating in the hybrid-antenna mode 504, the apparatus may (i) measure a signal quality of a neighbor cell utilizing at least one of two or more antennas and (ii) use RxD to receive transmissions from the serving cell utilizing the two or more antennas. By operating in the hybrid-antenna mode 504, the apparatus benefits from the improved reception capabilities associated with using two (or more) antennas while also benefiting from the capability of measuring signal qualities of neighbor cells.

In some circumstances, while operating in the hybrid-antenna mode 504, the apparatus may determine whether to change operation from the hybrid-antenna mode 504 to the single-antenna mode 502 based on signal qualities of the serving cell. For instance, the apparatus may perform such a determination when signal qualities improve while the apparatus is operating in the hybrid-antenna mode 504. For example, while operating in the hybrid-antenna mode 504, at block 512, the apparatus may determine whether the RxQual has a value equal to or less than one (1) and/or whether the BEP has a value greater than 29. If neither the RxQual has a value equal to or less than one (1) nor the BEP has a value greater than 29, the apparatus may remain operating in the hybrid-antenna mode 504. However, if the RxQual has a value equal to or less than one (1) and/or the BEP has a value greater than 29, the apparatus may change operation from the hybrid-antenna mode 504 to the single-antenna mode 502.

In some other circumstances, while operating in the hybrid-antenna mode 504, the apparatus may determine whether to change operation from the hybrid-antenna mode 504 to the RxD-only mode 506. For instance, the apparatus may perform such a determination when signal qualities deteriorate while the apparatus is operating in the hybrid-antenna mode 504. For example, while operating in the hybrid-antenna mode 504, at block 514, the apparatus may determine whether the RxQual has a value greater than two (2) and/or whether the BEP has a value less than 28. If neither the RxQual has a value greater than two (2) nor the BEP has a value less than 28, the apparatus may remain operating in the hybrid-antenna mode 504. However, if the RxQual has a value greater than two (2) and/or the BEP has a value less than 28, the apparatus may change operation from the hybrid-antenna mode 504 to the RxD-only mode 506.

Because the RxD-only mode 506 may allow the apparatus to utilize (at least) two antennas for communication with the serving cell, the apparatus may benefit from improved signal quality. However, the RxD-only mode 506 may have some limitations. For instance, the RxD-only mode 506 may suffer from an increased likelihood of a disconnection in communication (e.g., a dropped call), as described in greater detail above. Also, the amount of power consumed by an apparatus operating in the RxD-only mode exceeds the amount of power consumed by an apparatus operating in various other modes, such as the single-antenna mode and/or the hybrid-antenna mode. Over time, as the apparatus moves from one location to another location, the signal qualities may improve while the apparatus is operating in the RxD-only mode. The apparatus may determine whether to change operation from the RxD-only mode 506 to another mode, such as the hybrid-antenna mode 504. For example, while operating in the RxD-only mode 506, at block 516, the apparatus may determine whether the RxQual has a value less than or equal to one (1) and/or whether the BEP has a value greater than 29. If neither the RxQual has a value less than or equal to one (1) nor the BEP has a value greater than 29, the apparatus may remain operating in the RxD-only mode 506. However, if the RxQual has a value less than or equal to one (1) and/or the BEP has a value greater than 29, the apparatus may change operation from the RxD-only mode 506 to the hybrid-antenna mode 504.

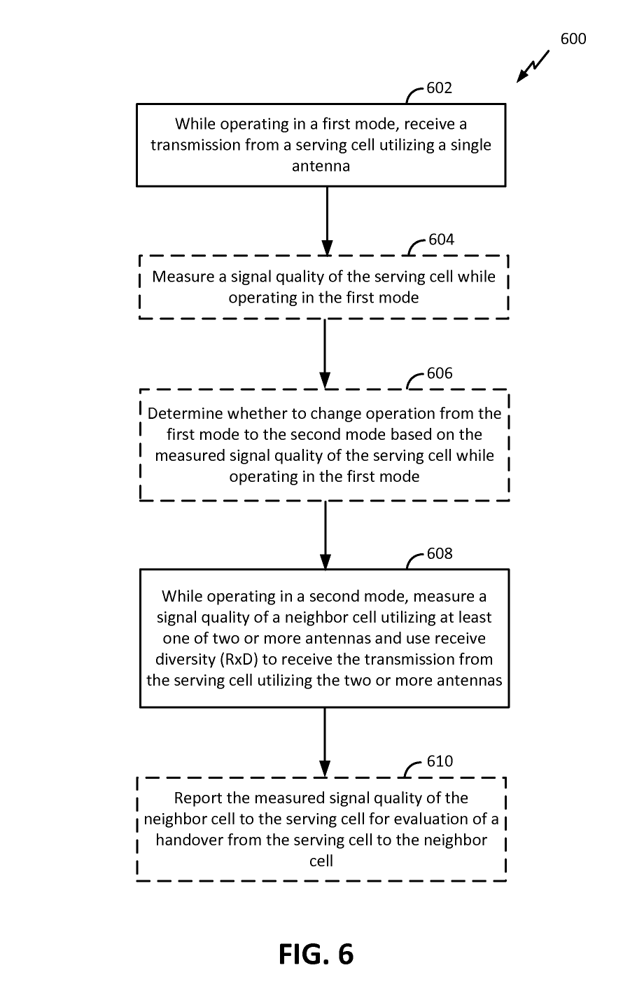

FIG. 6 is a diagram 600 illustrating various examples of methods and/or processes performed by an apparatus. Such an apparatus may be any of the apparatuses described herein (e.g., apparatus 100, 100-a2). At block 602, while operating in a first mode, the apparatus may receive a transmission from a serving cell utilizing a single antenna. For example, referring to FIGS. 2 and 3, while operating in the single-antenna mode, the apparatus 100, 100-a2 may receive a transmission from the serving cell 302-a utilizing only antenna 270a.

In some configurations, at block 604, the apparatus may measure a signal quality of the serving cell while operating in the first mode. For example, referring to FIGS. 2 and 3, the apparatus 100, 100-a2 may measure the quality of the signal from the serving cell 302-a. At block 606, the apparatus may determine whether to change operation from the first mode to a second mode based on the measured signal quality of the serving cell while operating in the first mode. For example, referring to FIG. 5, at block 510, the apparatus may determine whether the RxQual has a value that exceeds two (2) and/or whether the BEP has a value below 28. If neither the RxQual has a value that exceeds two (2) nor the BEP has a value below 28, the apparatus may remain operating in the single-antenna mode 502. However, if the RxQual has a value that exceeds two (2) and/or the BEP has a value below 28, the apparatus may change operation from the single-antenna mode 502 to the hybrid-antenna mode 504.

At block 608, while operating in the second mode, the apparatus may measure a signal quality of a neighbor cell utilizing at least one of two or more antennas and use RxD to receive the transmission from the serving cell utilizing the two or more antennas. For example, referring to FIGS. 2 and 3, while operating in the hybrid-antenna mode, the apparatus 100, 100-a2 may measure the signal quality of the neighbor cell 302-b utilizing antenna 270a and use RxD to receive the transmission from the serving cell 302-a utilizing antennas 270a, 270b.

In some configurations, at block 610, the apparatus may report the measured signal quality of the neighbor cell to the serving cell for evaluation of a handover from the serving cell to the neighbor cell. For example, referring to FIGS. 2 and 3, the apparatus 100, 100-a2 may report (e.g., via a transmission) the measured signal quality of the neighbor cell 302-b to the serving cell 302-a such that the serving cell 302-a can evaluate a handover from the serving cell 302-a to the neighbor cell 302-b.

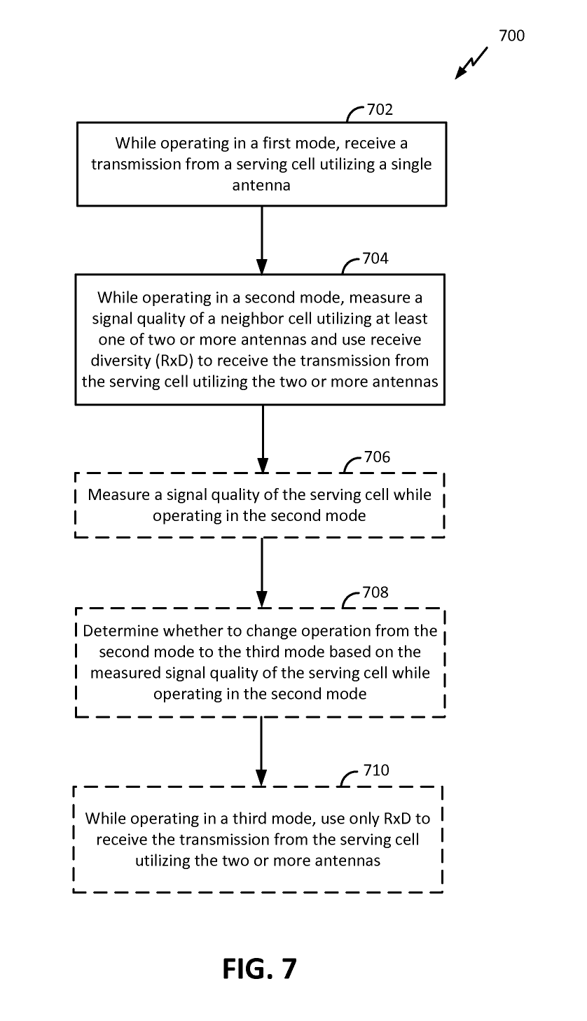

FIG. 7 is a diagram 700 illustrating various examples of methods and/or processes performed by an apparatus. Such an apparatus may be any of the apparatuses described herein (e.g., apparatus 100, 100-a2). At block 702, while operating in a first mode, the apparatus may receive a transmission from a serving cell utilizing a single antenna. For example, referring to FIGS. 2 and 3, the apparatus 100, 100-a2 may receive a transmission from the serving cell 302-a utilizing only antenna 270a.

At block 704, while operating in the second mode, the apparatus may measure a signal quality of a neighbor cell utilizing at least one of two or more antennas and use RxD to receive the transmission from the serving cell utilizing the two or more antennas. For example, referring to FIGS. 2 and 3, while operating in the hybrid-antenna mode, the apparatus 100, 100-a2 may measure the signal quality of the neighbor cell 302-b utilizing antenna 270a and use RxD to receive the transmission from the serving cell 302-a utilizing antennas 270a, 270b.

In some configurations, at block 706, the apparatus may measure a signal quality of the serving cell while operating in the second mode. For example, referring to FIG. 3, the apparatus 100-a2 may measure the quality of the signal of the serving cell 302-a while operating in the hybrid-antenna mode. At block 708, the apparatus may determine whether to change operation from the second mode to the third mode based on the measured signal quality of the serving cell while operating in the second mode. For example, referring to FIG. 5, at block 514, the apparatus may determine whether the RxQual has a value greater than two (2) and/or whether the BEP has a value less than 28. If neither the RxQual has a value greater than two (2) nor the BEP has a value less than 28, the apparatus 100-a2 may remain operating in the hybrid-antenna mode 504. However, if the RxQual has a value greater than two (2) and/or the BEP has a value less than 28, the apparatus 100-a2 may change operation from the hybrid-antenna mode 504 to the RxD-only mode 506.

In some configurations, at block 710, while operating in a third mode, the apparatus may use only RxD to receive the transmission from the serving cell utilizing two or more antennas. For example, referring to FIGS. 2 and 3, the apparatus 100, 100-a2 may use only RxD to receive the transmission from the serving cell 302-a utilizing antennas 270a, 270b.

One of ordinary skill in the art will understand that the apparatus 100, 100-a2 may be configured to perform various other operations and functions without deviating from the scope of the present disclosure. For instance, in some configurations, an apparatus (e.g., apparatus 100, 100-a2) may change operation to a particular mode (e.g., single-antenna mode 502, hybrid-antenna mode 504, RxD-only mode 506) based on the type of channel associated with the communication. For example, for a fast associated control channel (FACCH) where a handover command is received, the apparatus (e.g., apparatus 100, 100-a2) may change operation to the RxD-only mode 506. Because a FACCH may be indicated by a sealing flag (SF), any traffic bursts having a SF may trigger the apparatus (e.g., apparatus 100, 100-a2) to change operation to the RxD-only mode 506. One of ordinary skill in the art will understand that such an apparatus (e.g., apparatus 100, 100-a2) may change operation to a particular mode based on various other types of channels associated with the communication without deviating from the scope of the present disclosure.

The description herein is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method of wireless communication by an apparatus, the method comprising:
while the apparatus is operating in a first mode, receiving a transmission from a serving cell utilizing a single antenna; and
while the apparatus is operating in a second mode, measuring a signal quality of a neighbor cell utilizing at least one of two or more antennas and concurrently receiving the transmission from the serving cell utilizing at least another one of the two or more antennas.

2. The method of claim 1, further comprising:
reporting the measured signal quality of the neighbor cell to the serving cell for evaluation of a handover of the apparatus from the serving cell to the neighbor cell.

3. The method of claim 1, further comprising:
measuring a signal quality of the serving cell while the apparatus is operating in the first mode; and
determining whether to change operation of the apparatus from the first mode to the second mode based on the measured signal quality of the serving cell while the apparatus is operating in the first mode.

4. The method of claim 1, further comprising:
while the apparatus is operating in a third mode, using only receive diversity (RxD) to receive the transmission from the serving cell utilizing the two or more antennas.

5. The method of claim 4, further comprising:
measuring a signal quality of the serving cell while the apparatus is operating in the second mode; and
determining whether to change operation of the apparatus from the second mode to the third mode based on the measured signal quality of the serving cell while the apparatus is operating in the second mode.

6. The method of claim 4, wherein:
the first mode comprises a single-antenna mode;
the second mode comprises a hybrid-antenna mode; and
the third mode comprises an RxD-only mode.

7. The method of claim 1, further comprising:
selecting which of the two or more antennas to utilize for measuring the signal quality of the neighbor cell based on a relative strength of signals received at the two or more antennas,
wherein a strength of a signal received at the at least one of the two or more antennas for measuring the signal quality of the neighbor cell is weaker than a strength of a signal received at the at least another one of the two or more antennas for the transmission from the serving cell.

8. The method of claim 1, wherein the transmission from the serving cell comprises bursts on a traffic channel (TCH) in a Global Systems for Mobile Communications (GSM) network.

9. An apparatus for wireless communication, the apparatus comprising:
a transceiver comprising two or more antennas;
a memory; and
at least one processor coupled to the memory and configured to:
while the apparatus is operating in a first mode, receive a transmission from a serving cell utilizing a single antenna of the two or more antennas; and
while the apparatus is operating in a second mode, measure a signal quality of a neighbor cell utilizing at least one of the two or more antennas and concurrently receive the transmission from the serving cell utilizing at least another one of the two or more antennas.

10. The apparatus of claim 9, wherein the at least one processor is further configured to:
report the measured signal quality of the neighbor cell to the serving cell for evaluation of a handover of the apparatus from the serving cell to the neighbor cell.

11. The apparatus of claim 9, wherein the at least one processor is further configured to:
measure a signal quality of the serving cell while the apparatus is operating in the first mode; and
determine whether to change operation of the apparatus from the first mode to the second mode based on the measured signal quality of the serving cell while the apparatus is operating in the first mode.

12. The apparatus of claim 9, wherein the at least one processor is further configured to:
while the apparatus is operating in a third mode, use only receive diversity (RxD) to receive the transmission from the serving cell utilizing the two or more antennas.

13. The apparatus of claim 12, wherein the at least one processor is further configured to:
measure a signal quality of the serving cell while the apparatus is operating in the second mode; and
determine whether to change operation of the apparatus from the second mode to the third mode based on the measured signal quality of the serving cell while the apparatus is operating in the second mode.

14. The apparatus of claim 12, wherein:
the first mode comprises a single-antenna mode;
the second mode comprises a hybrid-antenna mode; and
the third mode comprises an RxD-only mode.

15. The apparatus of claim 9, wherein the at least one processor is further configured to:
select which of the two or more antennas to utilize for measuring the signal quality of the neighbor cell based on a relative strength of signals received at the two or more antennas,
wherein a strength of a signal received at the at least one of the two or more antennas for measuring the signal quality of the neighbor cell is weaker than a strength of a signal received at the at least another one of the two or more antennas for the transmission from the serving cell.

16. The apparatus of claim 9, wherein the transmission from the serving cell comprises bursts on a traffic channel (TCH) in a Global Systems for Mobile Communications (GSM) network.

17. A non-transitory computer-readable medium comprising computer-executable code configured to:
while operating in a first mode, receive a transmission from a serving cell utilizing a single antenna; and
while operating in a second mode, measure a signal quality of a neighbor cell utilizing at least one of two or more antennas and concurrently receive the transmission from the serving cell utilizing at least another one of the two or more antennas.

18. The non-transitory computer-readable medium of claim 17, wherein the computer-executable code is further configured to:
report the measured signal quality of the neighbor cell to the serving cell for evaluation of a handover of the apparatus from the serving cell to the neighbor cell.

19. The non-transitory computer-readable medium of claim 17, wherein the computer-executable code is further configured to:
measure a signal quality of the serving cell while operating in the first mode; and
determine whether to change operation from the first mode to the second mode based on the measured signal quality of the serving cell while operating in the first mode.

20. The non-transitory computer-readable medium of claim 17, wherein the computer-executable code is further configured to:
while operating in a third mode, use only receive diversity (RxD) to receive the transmission from the serving cell utilizing the two or more antennas.

21. The non-transitory computer-readable medium of claim 20, wherein the computer-executable code is further configured to:
measure a signal quality of the serving cell while operating in the second mode; and
determine whether to change operation from the second mode to the third mode based on the measured signal quality of the serving cell while operating in the second mode.

22. The non-transitory computer-readable medium of claim 20, wherein:
the first mode comprises a single-antenna mode;
the second mode comprises a hybrid-antenna mode; and
the third mode comprises an RxD-only mode.

23. The non-transitory computer-readable medium of claim 17, wherein the computer-executable code is further configured to:
select which of the two or more antennas to utilize for measuring the signal quality of the neighbor cell based on a relative strength of signals received at the two or more antennas,
wherein a strength of a signal received at the at least one of the two or more antennas for measuring the signal quality of the neighbor cell is weaker than a strength of a signal received at the at least another one of the two or more antennas for the transmission from the serving cell.

24. An apparatus for wireless communication, the apparatus comprising:
means for receiving a transmission from a serving cell utilizing a single antenna while the apparatus is operating in a first mode while the apparatus is operating in a first mode; and
means for measuring a signal quality of a neighbor cell utilizing at least one of two or more antennas and concurrently receiving the transmission from the serving cell utilizing at least another one of the two or more antennas while the apparatus is operating in a second mode.

25. The apparatus of claim 24, further comprising:
means for reporting the measured signal quality of the neighbor cell to the serving cell for evaluation of a handover of the apparatus from the serving cell to the neighbor cell.

26. The apparatus of claim 24, further comprising:
means for measuring a signal quality of the serving cell while the apparatus is operating in the first mode; and
means for determining whether to change operation of the apparatus from the first mode to the second mode based on the measured signal quality of the serving cell while the apparatus is operating in the first mode.

27. The apparatus of claim 24, further comprising:
means for using only RxD to receive the transmission from the serving cell utilizing the two or more antennas of the apparatus while the apparatus is operating in a third mode.

28. The apparatus of claim 27, further comprising:
means for measuring a signal quality of the serving cell while the apparatus is operating in the second mode; and
means for determining whether to change operation of the apparatus from the second mode to the third mode based on the measured signal quality of the serving cell while the apparatus is operating in the second mode.

29. The apparatus of claim 27, wherein:
the first mode comprises a single-antenna mode;
the second mode comprises a hybrid-antenna mode; and
the third mode comprises an RxD-only mode.

30. The apparatus of claim 24, wherein the means for measuring is configured to:
select which of the two or more antennas to utilize for measuring the signal quality of the neighbor cell based on a relative strength of signals received at the two or more antennas,
wherein a strength of a signal received at the at least one of the two or more antennas for measuring the signal quality of the neighbor cell is weaker than a strength of a signal received at the at least another one of the two or more antennas for the transmission from the serving cell.
